(19) United States
(12) Patent Application Publication
(10) Pub. No.: US 2026/0212298 A1
(43) Pub. Date: Jul. 23, 2026

(54) METHOD FOR PERFORMING DIRECTORS AND OFFICERS RISK ASSESSMENT USING A DATA-SCIENCE AND RISK PREDICTION MODEL

(71) Applicant: PREDICDO LTD., Givataim (IL)

(72) Inventors: Zohar YAKHINI, Ramat HaSharon (IL); Eran TAL, Ramat HaSharon (IL); Ilan GEFFEN, Ramat Gan (IL); Shay DUBI, Tel Aviv (IL)

(21) Appl. No.: 19/144,353

(22) PCT Filed: Dec. 29, 2023
(86) PCT No.: PCT/IL2023/051338

§ 371 Date: Jun. 27, 2025

Related U.S. Application Data
(60) Provisional application No. 63/435,898, filed on Dec. 29, 2022.

(51) Int. Cl. G06Q 10/0635; G06N 20/20; G06Q 10/0639

(52) U.S. Cl. CPC G06Q 10/0635; G06N 20/20; G06Q 10/06393; G06Q 10/06398

(57) ABSTRACT

The present invention is directed to a method, performed by a computer system, for the prediction of the directors and officers (D&O) risk of a query company, wherein said method is based on the use of machine learning to construct a quantitative risk-prediction model based on features produced from data that has been acquired from a plurality of data sources, and to train and validate said model. One key aspect of the invention is that the prediction model uses both features related to the query company and features related to the directors and officers of said company.

### FIELD OF THE INVENTION

The present invention is concerned with a method for assessing Directors and Officers (D&O) risk. More specifically, the method of the present invention uses a data-science and risk prediction model focused specifically on D&O, in order to predict D&O related risk.

### BACKGROUND OF THE INVENTION

In the corporate world, it is fairly common that employees, shareholders, customers, suppliers or any other interested party may initiate legal action against company directors and officers for alleged (or actual) wrong acts performed during their course of their management of said company. In many cases, the company will arrange for insurance cover (known as a Directors and Officers, or ‘D&O’ policy) to protect the directors and officers, as well as (in some cases) the company itself. This insurance cover provides the financial backing for the standard indemnification provisions found in contracts between the officers and the company, wherein said provisions hold the officers harmless for any financial losses which may arise as the result of the performance of their management or leadership role in the company.

D&O insurance covers the risk of the officers being sued for a variety of reasons relating to the officers' business or management activities (e.g. fraud, misuse of funds, breach of workplace laws etc.). It does not, however, generally provide cover for intentionally-performed illegal acts.

In responding to a request to provide D&O insurance, the insurance company must determine the risk that the proposed insurance will present. Knowledge of this risk can then be used, firstly, to decide whether it would be safe for the insurers to offer the requested policy, and secondly, to determine the level of the policy premium. In addition, the risk assessment can be used to guide the insurance company to include certain exclusions in the policy, or to set a deductible threshold. Many different methods of D&O risk assessment have been proposed and used. Basic factors that are taken into account in the analysis include general information relating to the company's requested liability limits, exclusions and deductibles, as well as a consideration of the company's assets. However, it is clearly of great importance that other, more specific risk factors are taken into account. Some of these relate to the company itself, including: the specific industry in question, the number of years that the company is active or has traded, recent and prospective mergers and acquisitions, profitability, cash flow, and so on. While such factors may provide insight into certain aspects of the company's present and past financial health and behavior, methods that only take into account said factors lack predictive strength and accuracy-primarily because they do not make any consideration of a primary source of D&O risk, namely the Directors and Officers themselves. Thus, for example, some methods, such as that disclosed in US2011196808 (entitled “System and Method for Directors and Officers Risk Assessment”) are directed to an assessment of a financial institution's capital risk and are based on a consideration of corporate financial data. The claimed method does not take into account the company's legal history and, more importantly, does not include any inputs related to the financial, employment and legal histories of the Directors and Officers themselves.

Similarly, the method of U.S. Pat. No. 8,452,620 (“Parametric directors and officers insurance and reinsurance contracts, and related financial instruments”), does not include any consideration of the Directors and Officers history, or of the legal history of the company.

In addition, many prior art methods of assessing D&O risk are based on a trend-based analysis. While there is clearly some merit to predicting future events on the basis of past behavior or financial status, such an approach is very limited in assessing a type of risk that is dependent on the interaction between many different factors, including human ones. It would therefore be highly advantageous if D&O risk could be evaluated using a data science model in which a plurality of data elements and the way in which they relate to each other and to real-world entities are taken into consideration.

The main object of the present invention is to provide a method of D&O risk assessment that uses feature-based modeling, and which overcomes the problems and limitations inherent in the prior art methods.

### SUMMARY OF THE INVENTION

The present invention is primarily directed to a means for assessing directors and officers (D&O) lawsuit risk using a data-science and risk prediction model focused specifically on D&O.

The process is based on data engineering and synthesis and the application of machine learning to construct a model comprising a plurality of potential risk factors to predict the D&O related risk.

In one aspect, the present invention provides a method, performed by a computer system, for the prediction of the D&O risk or liability of a query company, wherein said method comprises the steps of:
a) Using machine learning to construct a quantitative risk-prediction model based on features produced from data that have been acquired from a plurality of data sources, and to train and validate said model;
b) Deriving the D&O risk of said company using said risk-prediction model;
c) Providing a report which provides a quantitative measure of the D&O risk of said query company;
   wherein said features comprise both features related to said query company and features related to the directors and officers of said query company.

In one preferred embodiment of the above-defined method, the step of constructing and training the risk-prediction model (i.e., step (a), above) comprises the following sub-steps:
i) acquiring data from a plurality of data sources;
ii) processing the acquired data into a form suitable for further processing;
iii) merging processed data of different source types into a single datasheet or dataframe, wherein said different source types are selected from the group consisting of company data sources, financial filings, legal case sources and news and social media sources;
iv) resolving chosen elements of the processed data into features;
v) selecting features by means of an assessment process that statistically measures the relation of each feature to the D&O risk;
vi) applying a decision tree classifier and/or a naïve Bayes classifier to the selected features, in order to create and train the risk-prediction model;
It is to be noted that the terms ‘datasheet’, ‘database’ and ‘dataframe’ are used interchangeably throughout this disclosure, and all of said terms essentially refer to a two-dimensional array of data. Commonly, such arrays are stored in spreadsheets or similar files, often in comma-separated value (csv) or JSON formats. However, it is to be appreciated that the method of the present invention may be implemented in many different computer systems, using programs encoded in different languages that perform operations data stored in arrays held in any suitable file format.

The term ‘query company’ is used herein to refer to the company for which an assessment of D&O liability is sought. As such, this term is to be distinguished from the phrases ‘other company’, ‘other companies’ and the like which, in the context of this disclosure, generally refer either to past (or even present) companies other than the query company, at which the executives of said query company were/are employed. The term may also be used to refer to other companies who form part of a reference group (such as companies belonging to the same industrial sector) as the query company.

In many embodiments of the present method as disclosed hereinabove, the aforementioned features comprise one or more of the following types of feature:
a) features based on events and/or other qualitative and quantitative data that occurred during the current or past employment of current or past directors and executives;
b) features based on events and/or other qualitative and quantitative data that occurred before current or past employment of current or past directors and executives;
c) features based on events and/or other qualitative and quantitative data that occurred after current or past employment of current or past directors and executives;
wherein the features listed in sections a) to c) are selected from the group consisting of features related to (i) the query company, (ii) features related to a company other than the query company, in which current or past directors and executives have been or still are employed, (iii) features related to current directors and executives, and (iv) features related to past directors and executives.

It is to be noted that the term ‘feature’ is used herein in accordance with the usual meaning of this term in data science and machine learning, namely an individual measurable property or characteristic of a phenomenon that can be subjected to analysis.

The terms ‘employed’, ‘employment’ and the like are to be understood, in the context of the present disclosure to refer to any professional or commercial connection of a director or officer or other executive with a particular company, and in this regard, are not limited in scope only to working relationships which are defined by formal employer-employee contracts.

In one preferred embodiment of the method as defined hereinabove, the features are features based on D&O lawsuits filed against current or past directors and executives while employed at the query company or at another company.

In another preferred embodiment, the features comprise features based on D&O lawsuits filed against the query company or against another company in which current or past directors and executive are employed or have been employed in the past.

In a still further preferred embodiment, the features comprise features based on the financial parameters and/or financial ratios of the query company and/or one or more companies of current or past employment of current or past directors and executives of the query company. Examples of such financial parameters/ratios include (but are not limited to) R&D expenses, Selling, General and Administrative expenses, Long Term Debt Noncurrent, Other Liabilities Noncurrent and Revenues.

In some preferred embodiments, the features used in the method comprise features based on formal reports and/or SEC filings of companies at which current or past directors and executives are employed or were employed in the past. S-1/A report filings are one non-limiting example of such filings.

In other preferred embodiments of the present method, the features comprise features based on stock prices and traded values of companies at which current or past directors and executives are employed or were employed in the past.

In still further preferred embodiments, the features comprise features based on company ratings of the query company and/or other companies at which current or past directors and executives are employed or were employed in the past. Any suitable company rating may be used, but in one embodiment, said rating is an environmental, social, and governance (ESG) rating.

In another embodiment of the method, the features are based on news and events related to the query company and/or to other companies at which current or past directors and executives are employed or were employed in the past.

In a still further preferred embodiment of the method, the features related to the directors and officers of the query company are features pertaining to the employment history of said directors and officers and/or features pertaining to the experience, training, academic degree, gender, of current or past directors and executives of the query company.

In other embodiments, the features that are related to the directors and officers of the company comprise features pertaining to lawsuits involving currently serving directors during their period of employment at the query company and/or during their period of employment in other companies.

In yet another embodiment, the features that are related to the directors and officers of the query company comprise features pertaining to lawsuits involving other companies in which said directors and officers concurrently serve or in which they served during periods of prior employment.

Although the various embodiments of the method of the present invention may be implemented in relation to the query company by itself, in other embodiments of the method, the D&O risk is computed in the context of a specific market segment or industry sector. Thus, in some of these embodiments, the features used are selected from the group consisting of features pertaining to the query company, features relating to the directors and officers of said company, and features relating to the specific market segment.

In another preferred embodiment, the features are based on a comparison of distributions of financial parameters of the query company and on the comparison of the posterior density of a D&O lawsuit for said company.

In certain other embodiments of the present method, the features are selected from features based on the parameters of sibling companies, parent companies and/or child companies.

In still other embodiments, the quantitative prediction model used in the present method includes consideration of the features in relation to the geographical location of the query company.

In another preferred embodiment of the method of the present invention, the quantitative model used further comprises the following step-wise process:
a) prediction of a risk bin based on a model trained in past years;
b) mapping the query company to said risk bin by applying said model to the values of said company;
c) observing the fraction of events within every bin as inferred from considering a more recent history, based on the recent history of other companies that were mapped in said model;
d) computing the risk for the query company as the fraction observed in the bin to which it was mapped.

The timeframe of the ‘recent history’ referred to in step c) above can have any suitable duration. In some preferred embodiments, however, the duration may be the last three months, the last half calendar year and the last calendar year. Many other recent history durations (both longer and shorter) may also be selected, as required.

The various steps defined above will be described in more detail hereinbelow.

In another aspect, the present invention provides a computer system suitable for use in performing the method of the invention as defined hereinabove, wherein said computer system comprises one or more computerized processing devices, wherein said processing device is in communication with at least one memory device, at least one storage device and at least one output device, wherein said memory device(s), storage device(s) and/or said processing device(s) contain data derived from a plurality of data sources and computer-readable program code, and wherein said code is capable of being executed in order to perform a method of prediction of the D&O risk of a query company, as disclosed hereinabove, and to produce a visual report of the outcome of said method of prediction.

The term ‘visual report’ in this context includes within its scope one or more images on the screen or other display unit of a computer or other device, hard copies of the results of assessment, as well as reports generated by the computer and transferred to the clients and other users by electronic means (e.g., email and text messaging).

In a further aspect, the present invention also provides a software product comprising a non-transitory computer readable/writable medium in which resides computer-readable program code, said code being capable of being executed in order to perform a method of prediction of the D&O risk of a query company as disclosed and defined hereinabove, and wherein said software product is also capable of directing the production of a visual report of the outcome of said method of prediction. It is to be noted that said software product may be written using any suitable programming language, including, but not limited to Python, C++ and Java. A particularly preferred programming language for this purpose is Python.

### BRIEF DESCRIPTION OF THE DRAWINGS

FIG. 1 depicts the use of different data type sources in the method of the present invention.

FIG. 2 illustrates an example of one method for acquiring legal data (left side of figure) and data concerning complaints filed at the US Securities and Exchange Commission (SEC; right side of the figure), in order to create a legal dataset.

FIG. 3 depicts one example of a workflow that may be used to extract financial data from SEC 10-K filings.

FIG. 4 illustrates one example of a workflow used to generate a CSV data table containing information concerning the directors and officers associated with a certain company.

FIG. 5 schematically depicts the process of merging data from different data sources into a single datasheet.

FIG. 6 provides details of complex dataset preprocessing that is used as part of the data merging process.

FIG. 7 schematically illustrates the process of deriving executive prior lawsuit feature, in order to construct a ‘lawsuit’ datasheet.

FIG. 8 schematically depicts the process for creating a single datasheet containing the employment dates of individual executives at previous places of employment.

FIG. 9 schematically describes a method for obtaining the number of past jobs for each executive.

FIG. 10 illustrates an exemplary method for computing the average length of service of executives in previous positions.

FIG. 11 depicts how various activities at other companies may be obtained by means of merging other datasets with information about companies' activities

FIG. 12 illustrates an example of the computation of the number of D&O suits received by companies which are past employers of current and past executives of the query company.

FIG. 13 depicts a method for computing the number of D&O lawsuits received by companies which are past employers of current executives only.

FIG. 14 schematically depicts the binning of features by means of assigning them to threshold-defined bins according to their place within a defined numerical range.

FIG. 15 illustrates the conceptual basis of the calculation of the lift coefficient for each feature, and the mathematical formula used for said calculation.

FIG. 16 schematically shows the general data structure used within the multi-layered prediction model.

FIG. 17 graphically depicts the general structure of the predictive model, showing the inputs to the model, bin encoding of the features and the output from said model.

FIG. 18 schematically summarizes the general training flow of the predictive model and its different steps.

FIG. 19 shows the risk assessment section of a typical client report generated by the method and system of the present invention.

FIG. 20 provides an example of a part of the financial risk section of a typical report generated by the present invention.

FIG. 21 graphically illustrates a typical sector risk comparison, as found in the final section of a typical report generated by the method of the present invention.

FIG. 22 provides details of the calculations of the accuracy, recall and precision results of a test study of 1,000 different companies (Example 1).

FIG. 23 presents two performance-related graphs (PR curve and ROC curve) for test study described in Example 1.

### DETAILED DESCRIPTION OF PREFERRED EMBODIMENTS

In its most general form, the method of the present invention comprises the following steps:
a) Integrating data from several sources into a single database;
b) Data processing
c) Feature Engineering;
d) Statistical Analysis of Feature/Label Association;
e) Creation of Multi-Layered Prediction Model.

Each of these general steps will now be described in more detail.

### a) Integration of Data Originating in Multiple Sources

The process for building the predictive model comprises several steps, including data processing and merging, modelling and feature engineering as well as testing. However, the first step in this multi-stage process is the acquisition of data of different types, from a plurality of sources.

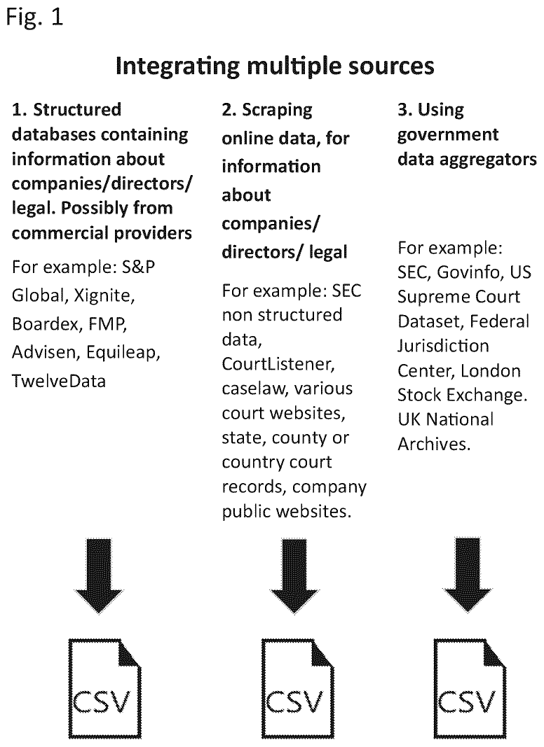

Examples of some of the types of raw data sources that are used to create the proprietary data are schematically represented in FIG. 1. As shown in this figure, in one embodiment of the invention, the data used to generate the predictive model is derived from three general source types:
i) Structured databases which contain information concerning companies, as well as their directors and officers, as well as some legal data concerning the companies. In one preferred embodiment, these structured databases are commercial databases (for example, S&P Global, Xignite, Boardex, FMP, Advisen, Equileap and Twelve Data). In another embodiment, the structured company database is an in-house database constructed from non-commercial sources.
ii) Unstructured online data concerning companies, their officers and directors, and legal information concerning them. Examples of suitable sources include (but are not limited to) SEC unstructured data, CourtListener, case law, various court websites, state, county or country court records and publicly-available company websites. The data available in these various unstructured sources is subjected to web scraping, by which means the data of interest are imported into a local file or spreadsheet.
iii) Governmental data aggregators including, for examples, SEC, Govinfo, US Supreme Court Dataset, Federal Jurisdiction Center, London Stock Exchange, UK National Archives, and so on.

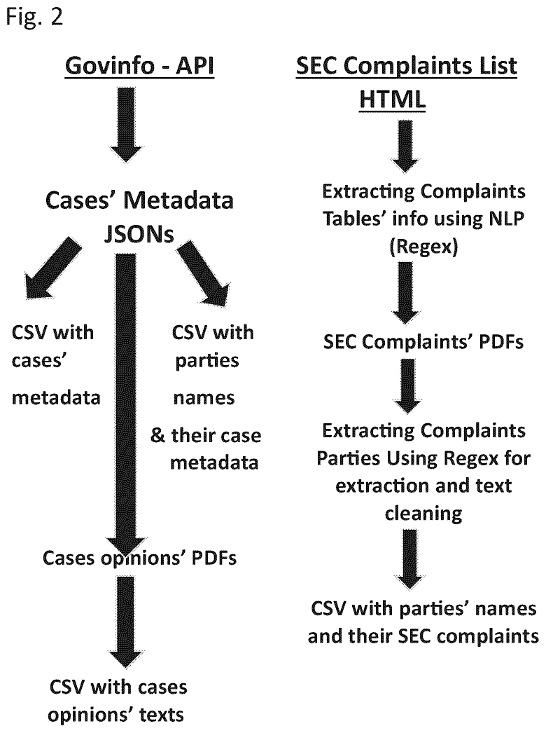

Several unique data processing pipelines are used in order to create the datasets utilized for creating each of the feature categories (such as financial parameters). These pipelines are described in detail including a description of important steps of our data acquisition phase and can be seen in FIGS. 2-4.

FIG. 2 illustrates an example of one method for acquiring legal data (left side of figure) and data concerning complaints filed at the US Securities and Exchange Commission (SEC; right side of the figure), in order to create a legal dataset for working the method of the present invention. In the examples shown in this figure, the various items of acquired data are stored in separate CSV files.

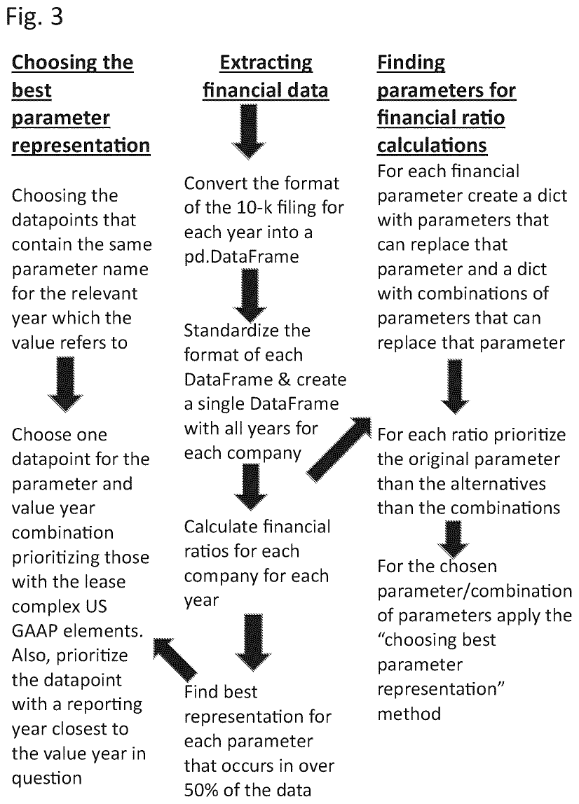

FIG. 3 depicts one example of a workflow that may be used to extract financial data from 10-K filings (i.e. the submission of a standard SEC report form, required by the SEC, providing a comprehensive summary of a company's financial performance). As shown in this figure, the workflow begins by converting some of the data in the 10-K filing into a 2-dimensional labeled data array (similar to a spreadsheet). The subsequent steps in the process include the calculation of representative financial ratios from the extracted data and the selection of the optimal types of ratio from a dataframe dictionary.

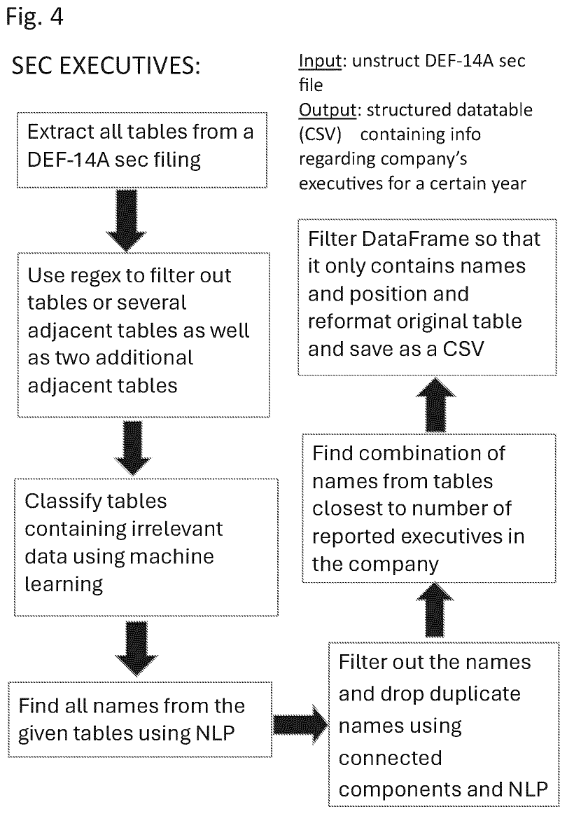

FIG. 4 illustrates one example of a workflow used to generate a CSV data table containing information concerning the directors and officers (executives) associated with a certain company, during a certain year. In this example, the raw data source is a set of tables from a DEF-14A SEC filing. The tables are subjected to several filtering and classifying steps in order to generate a table containing a set of non-duplicate names, corresponding in size to the reported number of executives at the query company.

### b) Data Processing

Following the acquisition of the data as described hereinabove, said data may be subjected to a number of initial processing steps, as well known to the skilled artisan in the field, including data de-noising, enrichment of the data for information relating to the company's directors and officers, and the merging of data from several sources.

### Enriching Executive/Director-Specific Information:

As explained elsewhere herein, one of the key features of the method of the present invention is the extensive use of data concerning the company's executives (directors and officers). Consequently, in a preferred embodiment of the invention, the information acquired is enriched for executive data. Said executive data is then used to deduce additional information for a given query company, thus further refining the dataset. This enrichment may be achieved by several different means, including incorporating additional sources of executive data into the processed dataset. The enriched data is then used for the model construction phase.

By way of example, this enrichment process may be accomplished by extracting data from the SEC filings such the 10-K as and the DEF 14A submissions. Next, segments that may potentially fit specific structures and executives' names are identified. These candidate executives are filtered, and the data is then subjected to various statistical methods as well as large language models (LLMs) to clean the data. Finally, multiple segments taken from different tables and regions of tables are merged into a single CSV table for each company, wherein said table contains information regarding executives' positions within the company and their period of service there.

### Merging Data Sources:

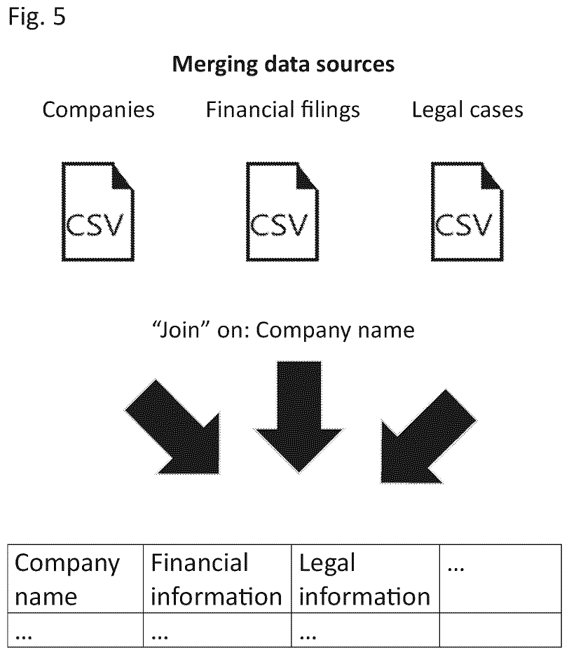

In the steps of the method performed so far, the various types of data (in terms of their subject matter) have been kept separately, in different datasheets. In order to proceed with the method, the next step is to merge these various data sources, in order to synthesize a single datasheet. This step is summarized in FIG. 5, which shows an example of this process in which individual structure datasheets containing data concerning (i) companies, (ii) financial filings, and (iii) legal cases are merged into a single database. During the merging process a common field such as ‘company name’ may be used in order to facilitate the synthesis of the data.

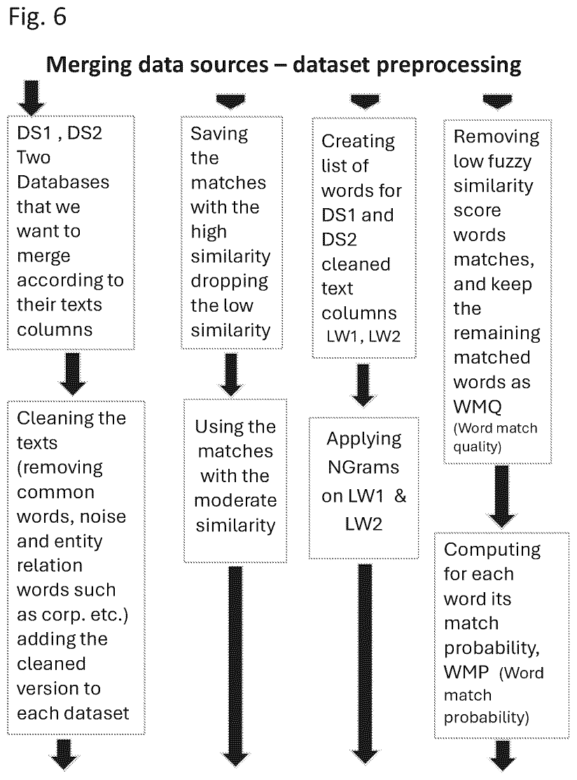

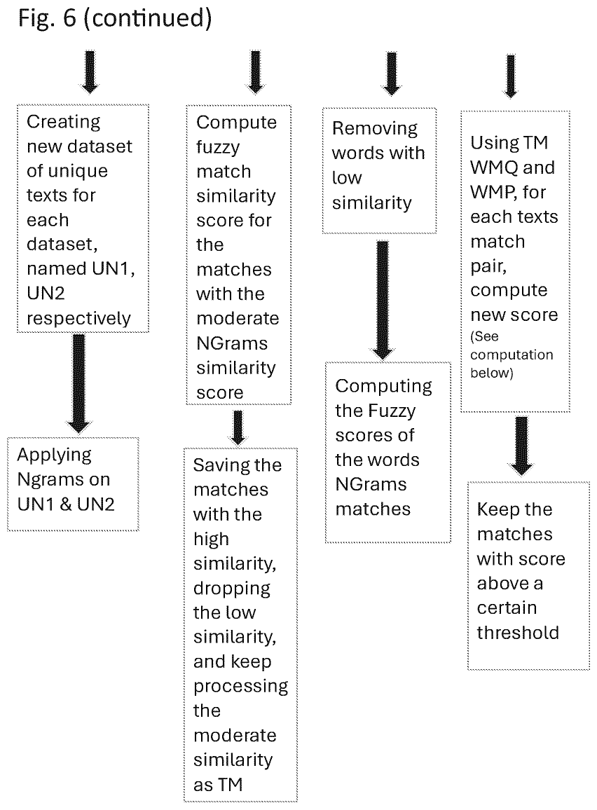

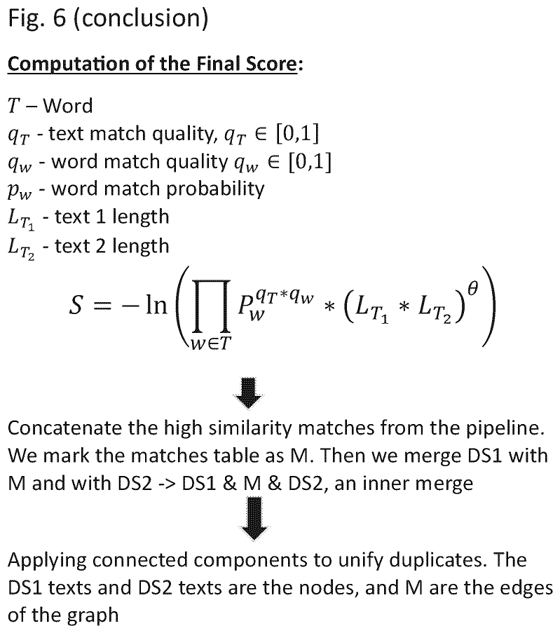

One problem which may arise during the merging process is ambiguity due to different versions of the same company name (e.g., “IBM”, “IBM co.” and “IBM corporation”) each of which will initially be treated as separate entities. Other examples of ambiguity include cases in which names consisting of a series or string of words differ by only one word-which could lead to the different names being construed as the same entity (for example: “Bank of America” and “Bank of Colorado”). Several other general sorts of ambiguity also exist. However, various modeling and NLP techniques are used in order to remove this ambiguity in the final dataset. In some cases, the processing that needs to take place is complex, as may be seen in the example shown in FIG. 6.

### c) Feature Engineering

The present invention utilizes different resolutions of information in order to predict the level of D&O risk of the query company. These data resolutions are expressed through the features used by the model and different pipelines are used in order to construct each type of feature. Non limiting examples of these features include:

Company features: these features draw direct information regarding the company covering different aspects such as funding, age, and activity. Examples of types of company features that may be used, as well as methods for their computations are as follows:

Two different time intervals may be selected:
Past year.
Lifetime

For both, count\sum\average are calculated for different features such as: number of lawsuits, number of founding rounds, total amount of funds raised, number of executives.

From these values, the following features (and their averages) are derived:
number of lawsuit in the past year, number of lawsuits in the company's lifetime, number of funding rounds in the past year, number of funding rounds in the company's lifetime, total amount of funds raised in the last year, total amount of funds raised in the company lifetime, past year executives' turnover rate.

The time passed since the last occurrence, time passed since median, the event most dominant type (mod) and the average month of year in which the events happened, are all calculated. Examples of such elapsed time parameters include:
time passed since the last company acquisition, time passed since the median of the companies' acquisitions on the time-line, the main type of acquisition (M&A, IPs acquisition, etc.) and average month in which the acquisitions occurred.

These parameters are commonly calculated for the following features:

Funding rounds, acquisitions, different types of lawsuits (including D&O and different types of D&O lawsuits, for example Securities Class Actions), executives' appointments, company events, SEC complaints, dividends, main shareholder change.

Features may also be derived from SEC financial filings and stock prices, as follows:

The SEC financial filings include Form 10K and other forms that reference allotment of shares or other continuous parameters. (Assets, liabilities, etc.)

For these parameters over the time-line the following values may be computed:
First derivative:
Change respectively to the last year:

$${P}_{y 1 , y 2} = \frac{{v}_{{y}_{1}}}{{v}_{{y}_{2}}} , D = {v}_{{y}_{1}} - {v}_{{y}_{2}}$$

Change respectively to the IPO:

$${P}_{y 1 , {y}_{IPO}} = \frac{{v}_{{y}_{1}}}{{v}_{{y}_{IPO}}} , D = {v}_{{y}_{1}} - {v}_{{y}_{IPO}}$$

Change respectively to 1 year after IPO
Second derivative:
Change in the change respectively to two years ago:

$$P {P}_{{y}_{1} , {y}_{2} , {y}_{3}} = \frac{{p}_{{y}_{1} , {y}_{2}}}{{p}_{{y}_{2} , {y}_{3}}} , D {D}_{{y}_{1} , {y}_{2} , {y}_{3}} = {P}_{{y}_{1} , {y}_{2}} - {P}_{{y}_{2} , {y}_{3}}$$

Geometric average on PP yearly values for the year of the IPO and the current year.
Average on DD yearly values from the year of the IPO and the current year.

For example, data for assets will yield features such as assets, current assets relative to the previous year's assets, change in current year assets and in previous year assets, and so on. For each computed feature, outliers are removed by testing several thresholds of quantiles and also testing several types of scale transformations (e.g., log, cbrt, etc.) along with standardization. The optimum transformation and outliers removal quantiles are chosen, using a single feature model, to predict the label.

Finally, the result is tested on a validation set.

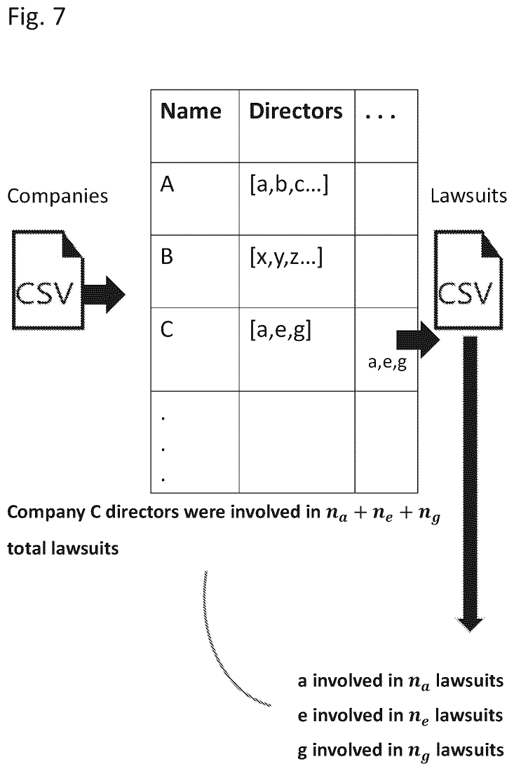

Executive features: these features use information regarding the executives (i.e., officers and directors) of the company, and are used to provide information regarding the risk conferred by individual executives of the company. This step incorporates information pertaining to other companies in which company executives (past and current) have worked. An example of the derivation of executive prior lawsuit features is shown in FIG. 7, from which it may be seen that data for this feature is obtained from a datasheet containing information concerning companies. The information concerning the number of lawsuits filed against individual executives at each company is then compiled in a separate ‘lawsuit’ datasheet.

Several different temporal resolutions are also applied in order to construct the features. The following discussion provides some examples of these different resolutions and the creation process:
The Executives features creation compose of 2 main phases:
i) Creating features regarding the executive herself/himself, and regarding the features of the companies that the executive served at.
ii) Creating executive-related features in the company dataset.

Creation of executives' dataset:

Seven different temporal perspectives regarding the executive and the companies he/she served at are examined:
What happened (past year) in the companies that the executive served at, during his service.
What happened (lifetime) in the companies the executive served at, during his service.
What happened (past year) in the companies that the executive served at, before and\or during and\or after his service.
What happened (lifetime) in the companies the executive served at, before and\or during and\or after his service.
What happened (past year) in the companies that the executive served at, before and\or after his service.
What happened in the companies after the executive finished serving at, before and\or after his service.
What happened during or one year after the executive has finished his service.

For each of these seven different temporal perspectives different operations including: sum, count, average, are calculated.

These temporal perspectives are then applied to company features, including:
funding rounds (for example: total number of funding rounds, total number of different companies that raised funding, total amount of money was raised, avg number of funding round per company), acquisitions, lawsuits (according to different types), state, country, is public, is private, Exit events, IPOs, was the company closed, executives' appointments and various financial parameters.

Some of the financial parameters are binned prior to the computation.

The count operation is used only for some of the features such as: state, country, Exit events, IPOs and was the company closed, for example.

In addition, features that relate to the executive himself may be computed. Examples of such features include: the number of companies the executive served at and is currently serving at (while distinguishing between private, public, government companies, and different types of entities like universities), number of degrees or certifications, average time serving in each position.

Computing the executive features in the company dataset:
Six different temporal perspectives regarding the executives of a company are considered:
Current executives
Recent executives—executives that finished their service within the last year
Past executives—executives that finished their service at least a year ago
Current+Recent executives
Past+Recent executives
Current+Recent+Past executives

For these six different temporal perspectives several operations (including sum, count and average) are applied in order to create the features.

These temporal perspectives are applied to the executives' features that were described hereinabove.

By way of example, for D&O lawsuits the following features may be computed:
number of D&O lawsuits of the companies that current executives served at, occurring within the last year, during the executive service.
number of D&O lawsuits of the companies that current executives served at, occurring in their entire lifetime, during the executive service.
number of D&O lawsuits of the companies that current executives served at, occurring after the executive finished his service.
number of D&O lawsuits of the companies that current executives served at, occurring within the last year. (after his service)
number of D&O lawsuits of the companies that current executives served at, occurring in their entire lifetime. (before and\or during and\or after his service)
number of D&O lawsuits of the companies that current executives served at, occurring within the last year. (before and\or after his service)
number of D&O lawsuits of the companies that current executives served at, occurring in their entire lifetime. (before and\or after his service)

These features may also be computed for the other temporal perspectives: recent, past, current+recent, past+recent, current+recent+past.

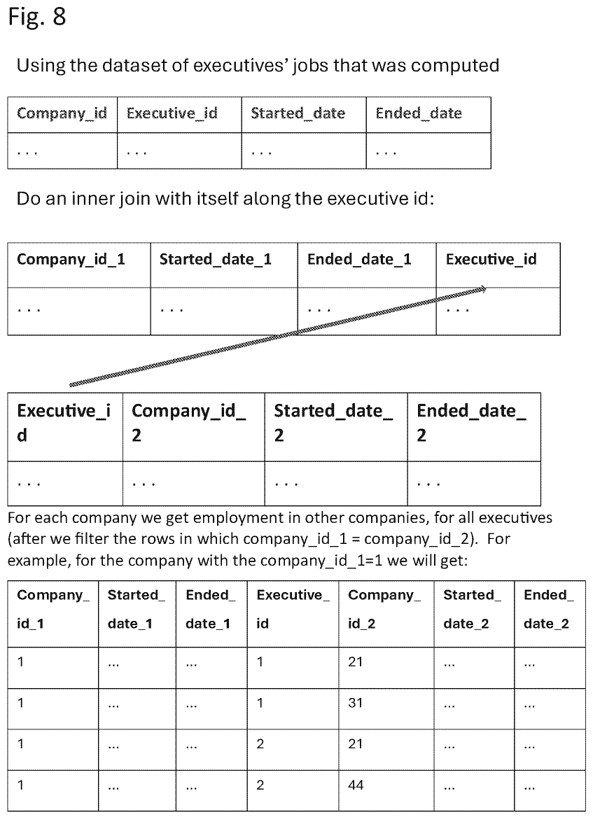

A detailed explanation and further examples of the executive features computation are shown in FIGS. 8-13.

FIG. 8 illustrates the process for creating a single datasheet containing the employment dates of individual executives in other (i.e., non-query) companies. As shown in the figure, this process begins with a datasheet containing details of executive's employment. These data are then processed by performing an inner join (within the same datasheet) according to the executive ID parameter. By these means, a table organized by executive ID showing each company of past employment for each executive is produced.

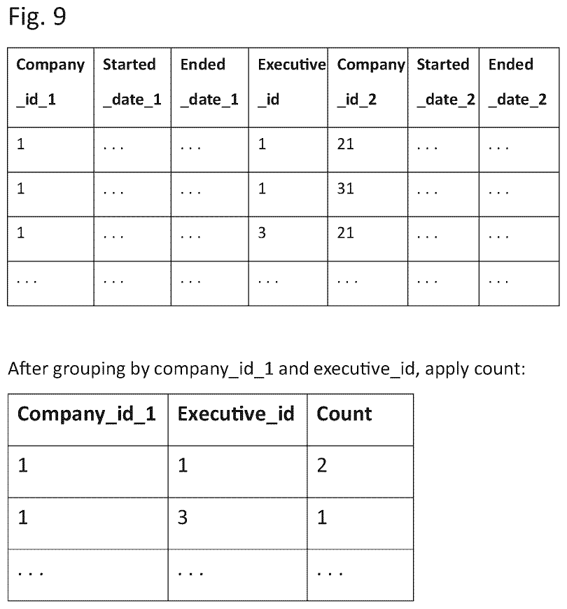

FIG. 9 describes a method for obtaining the number of past jobs for each executive. This is performed by means of grouping the company dataset according to the columns: company_id_1 and executive_id. The number of elements in each group is counted for each executive in a company, and the total number of jobs for that executive is derived.

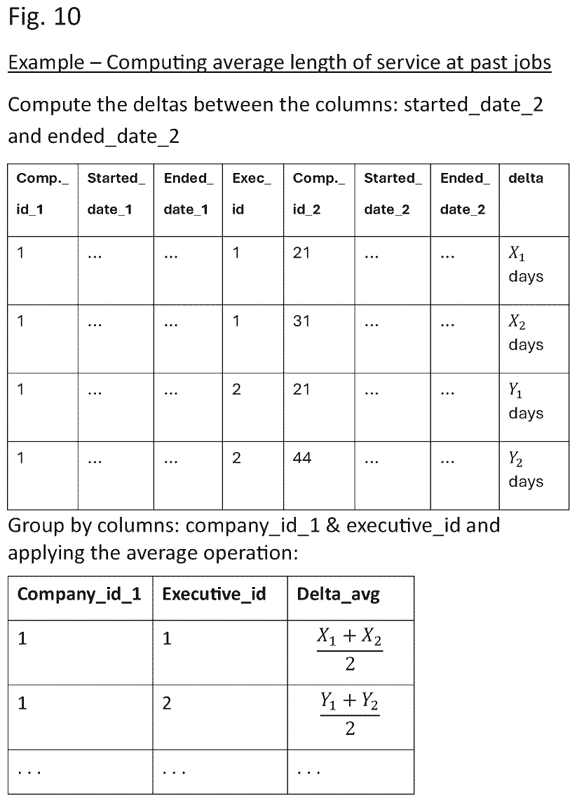

FIG. 10 describes an exemplary method for computing the average length of service at past jobs, involving the computation of the differences between the columns: started_date_2 and ended_date_2. An average value for each executive is then calculated.

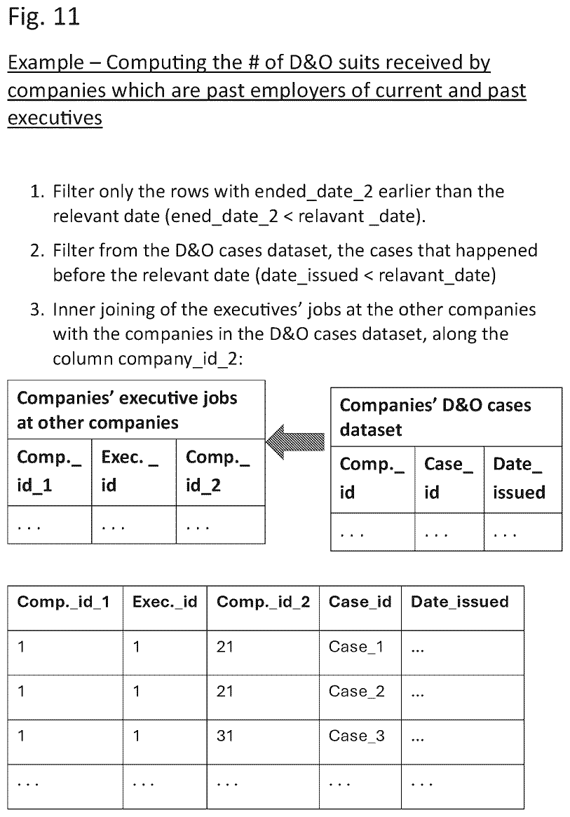

FIG. 11 illustrates how various activities at other companies may be obtained by means of merging other datasets with information about companies' activities along the column company_id_2. By these means, different types of calculations regarding these activities in the other companies that the executives served at can be performed. One example of such a calculation is as follows:

### Example—Computing the # of D&O Suits Received by Companies which are Past Employers of Current and Past Executives

1. Filter only the rows with ended_date_2 earlier than the relevant date (ened_date_2<relavant_date).
2. Filter from the D&O cases dataset, the cases that happened before the relevant date (date_issued<relavant_date)
3. Inner joining of the executives' jobs at the other companies with the companies in the D&O cases dataset, along the column company_id_2.

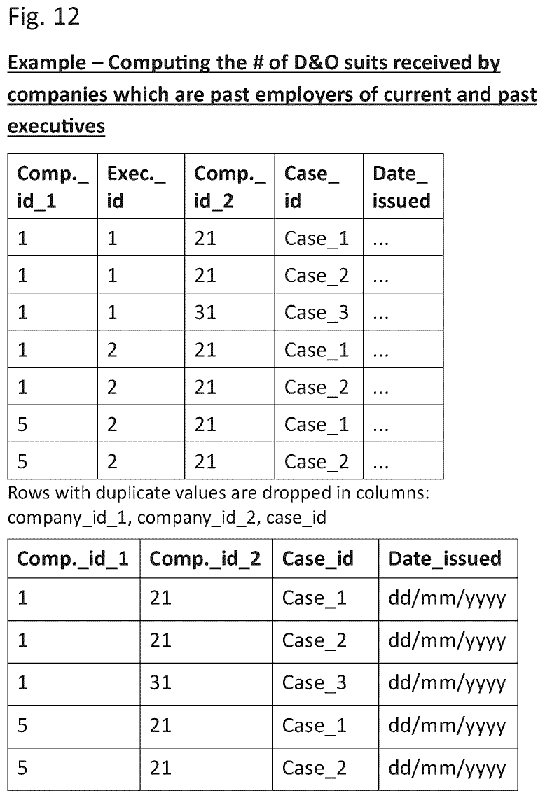

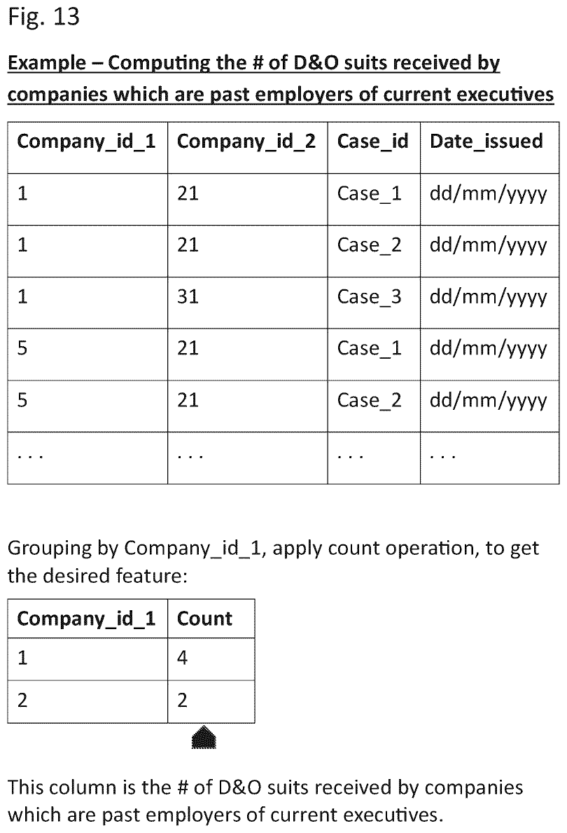

FIG. 12 shows an example of the computation of the number of D&O suits received by companies which are past employers of current and past executives of the query company. FIG. 13, on the other hand, depicts a method for computing the number of D&O lawsuits received by companies which are past employers of current executives only.

It will be appreciated from these examples that many different features may be derived from the data contained in the executive and company datasheets. The computations described above and illustrated in FIGS. 8-13 are provided as examples only, and the invention is not limited to these examples alone.

### d) Statistical Analysis of Feature/Label Association

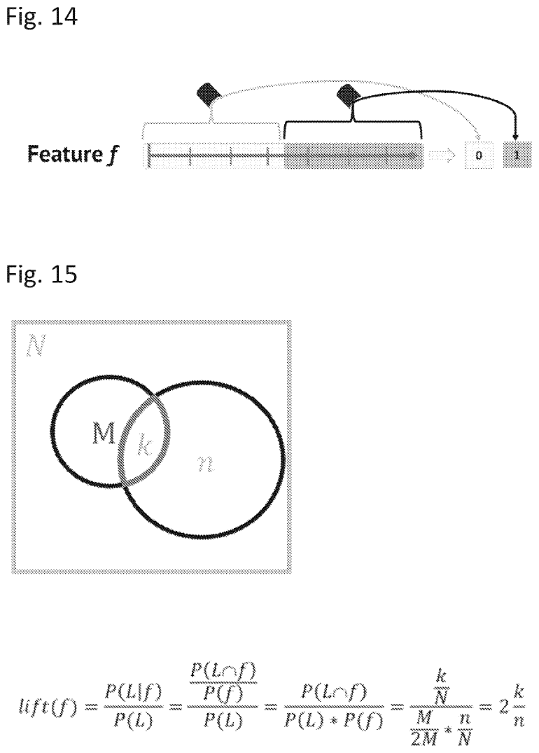

Having computed a series of company-related and executive-related features, the next step in the method is to assess, by means of statistical tests, the relation between each feature and the D&O risk, in order to assure the statistical integrity of our results. However, prior to performing these tests, the data is subjected to some further preprocessing techniques. One of these techniques is data cleansing, which is performed by means of filtering out commonly missing features, in order to prioritize features that are likely to be found for most companies, thereby ensuring the completeness of the data. A further optional preprocessing technique is the binning of the features, by means of assigning continuous feature values (i.e., in features which contain continuous data) to threshold-defined bins. This technique is illustrated in FIG. 14, which shows one portion of the value range of feature f (in this case the lower half of the numerical range) being categorized or assigned to bin ‘0’, that is the bin unassociated with D&O risk. The other portion of the range for this feature is, as shown in the figure, categorized in bin ‘1’ (associated with D&O risk).

Following these preprocessing steps, the lift coefficient for each feature may be calculated, using balanced data in the training set only, in order to statistically measure the relation between each feature and D&O related risk. The basis for this calculation is illustrated in FIG. 15, which shows the relation between the following variables:
N—the total number of samples in our balanced data
M—the number of samples with L=1 (involved in a D&O lawsuit)
n—the number of samples which have a certain feature f=1
k—the number of samples for which: L=1 and f=1

Since the data is balanced, 2M=N.

The lift coefficient of a feature f is calculated by means of the formula shown at the bottom of FIG. 15, wherein L denotes all samples with label=1 (|L|=M).

Following the calculation of the lift coefficients, several different statistical tests may be applied in order to assure the statistical integrity of the results. One such test is the one-sided hypergeometric test. The P-Value obtained from this test for a given feature represents the odds that the lift (the association between that parameter and the companies' risk) occurred by chance.

In addition, feature disjointification may be used to select a group of features that do not have a strong dependance upon each other. In one embodiment, the process is performed using the lift coefficient, but the association between features may also be investigated using other measurements such as pValue, Chi-square test, correlations (spearman, tau, person) and entropy.

Following the statistical analysis described above, the following features were identified as being of predictive value:
Company: D&O lawsuits filed against the company (Lifetime)
Company: Total number of lawsuits filed by the company (Lifetime)
Company: D&O lawsuits filed against the company (Past year)
Company: Number of executives turnover
Company: Total number of executives (Lifetime)
Current executives: Number of different states
Current executives serving at other companies which filed a lawsuit
Current executives: Served at public company
Current executives: Number of public companies (Lifetime)
Company: Total acquisitions
Current executives: Working in 2 or more countries
Current executives: Total number of companies (Lifetime)
Current executives other companies: Companies closed (During or less than 1 yr)
Current executives: Average number of D&O lawsuits filed against companies they served at—during their service
Current executives other companies: Average number of IPOs during their service (Lifetime)
Current executives other companies: Average number of acquisitions per director
Current executives other companies: Average lawsuits per executive
Current executives other companies: Average number of investors-during their service
Current executives other companies: Average number of funding rounds-during their service
Number of PX14A6N filings during the last year
Total number of general lawsuit cases filed by the company during its entire lifetime/in the last year
Current executives: working in 2 or more countries
Current executives: working in 2 or more states
Current executives other companies: Total number of general lawsuit cases filed by the company during its entire lifetime/in the last year
Current executives other companies: Average number of exit events during their service (Lifetime)
Current executives: Average number of other companies per executive (current)
Current executives: Average number of companies the executive served at
Current executives: Average number of public companies the executive served at
Current executives: Average number of private companies the executive served at

### e) Creation of Multi-Layered Prediction Model

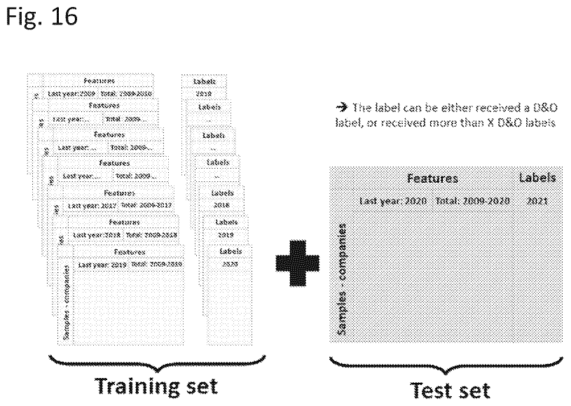

The general data structure used to enable the model's prediction with the available data is described in FIG. 16. As shown, the test set of data is arranged according to event year. The label can be either of the type “received a D&O label”, or “received more than X D&O labels”.

The model architecture which applies a unique combination of a decision trees and Naïve Bayes in order to construct a particular preferred architecture may be summarized as follows:

The model consists of two main phases:
1. A decision tree classifier
2. A naïve Bayes classifier

The model is tasked with predicting whether the company gets sued in the following year. The input into the model comprises a binary feature vector representing traits of a specific company. The output from the model is the query company's risk score representing the risk the company is going to be served a lawsuit in the following year, together with a vector containing the features having the highest effect on that company's risk (lift).

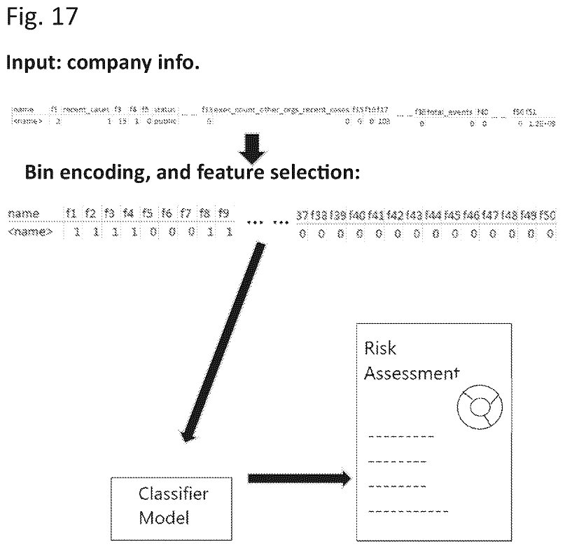

FIG. 17 graphically depicts the overall structure of the predictive model, with the input data (in this example, company data) at the top of the figure, bin encoding and feature selection in the middle, and the output, at the bottom, in the form of a report grouping the tested features into three different levels of risk (lift value).

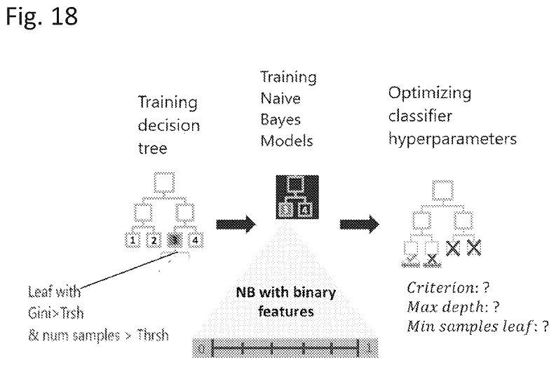

The general training flow of the predictive model and its different steps, considerations and hyper parameters are summarized in FIG. 18. Briefly, the training flow operates as follows:
The model first trains the decision tree using the Gini index as an impurity measure.
During that stage it has all of our selected features to select from for its nodes, so that it optimizes feature selection.
After the decision tree is trained, certain leaves are chosen according to impurity criteria and for each such leaf a naïve Bayes classifier is trained with the samples that ended up in that specific leaf, while reintroducing all the features to train with.

The hyperparameters used during the two phases of the training phase are as follows:

### Decision Tree:

1. Maximum depth—Determines the maximum number of splits the tree is allowed to make
2. Minimum sample split—Determines the minimal number of samples a node needs to contain for the tree to split it.
3. Minimum sample leaf—Determines the minimal number of samples required to be in a leaf resulting from a split.
4. Minimum impurity decrease—Determines the minimal decrease in impurity resulting from a split, required in order to make a split.
5. Classification threshold—Determines the “leaf sample to positive”-label proportion required in order to classify a sample as positive.

### Naïve Bayes:

1. Gini threshold-Determines the impurity score such that samples in leaves with an equal or higher score will continue to a naïve Bayes model
2. Leaf size threshold-Determines the minimal number of samples in a leaf, for its samples to continue to a naïve Bayes model
3. Classifier thresholds-A vector containing a threshold for each naïve Bayes model. Samples with a probabilistic outcome greater than the threshold will be classified as positive

It is to be noted that the trained model of the present invention, described hereinabove, may be used to generate different types of predictive results, including (but not limited to) binary classification results (e.g., whether a D&O lawsuit will be filed against the query company during the next year) and the answers to more complex questions (e.g., will the company be involved in three or more lawsuits in the following year?).

Having described hereinabove the various general stages of the process of building and applying the predictive model, the following section describes the manner in which financial information may be incorporated into the predictive model.

Thus, after extracting the raw financial parameters, several manipulations are performed in order to create financial parameters for use in the predictive model. These manipulations include but are not limited to:
Financial ratio calculation—this process requires computing financial ratios using specific representations of parameters that may differ in each report (i.e., possibly with different names, and possibly computed from other parameters)
For example, the current ratio parameter given by: current assets/current liabilities.
The change in a parameter is measured over specific periods of time either in percentage or by absolute numbers as well as the ‘stability’ of the company with regards to a specific financial parameter (std) or any combination of the computations mentioned above.

The approach to using financial data of this type consists of comparing the posterior probability of receiving a lawsuit, given a value for a financial parameter. More specifically:
1. Two distributions are constructed for each parameter, a, one pertaining to companies that were D&O sued in the past year and one pertaining to those that were not.
2. Gauss pdfs are estimated for these two distributions—call them fₐ and gₐ for the sued and not-sued populations of companies, respectively
3. Consider the query company q, and let a (q) be the value for the parameter a as observed for q. Then, fₐ(a(q)) and gₐ(a (q)) are compared to obtain a risk value for q, based on a.
4. This is done for all available financial parameters

In another aspect, the present invention is also directed to a user interface for reporting and describing the type and level of risk. This user interface is used to prepare a report for the end-user (usually the insurance company that ordered the risk-assessment). This report may be made available to the end-user online by means of a dedicated client interface, by means of electronic communication such as email or messaging services. In addition, the report may be printed, and a hard copy sent to the client.

In one embodiment, the report is separated into three main segments providing a coherent risk assessment for the underwriting process. The following section is a general description of one embodiment of the user interface and the different sections of the report.

### Company Risk Report:

A risk report regarding a company containing insights regarding its different risk factors is automatically produced. The report contains unique insights that were produced and carefully designed for the purpose of relaying proprietary data to the user. These reports constitute the main interaction of the users with the software by means of which the method of the present invention is performed, and the main source of visual marketing to said users. The report consists of several distinct segments which include:
Risk assessment
Financial risk factors
Sector risk comparison

The aforementioned risk assessment section of the interface or report consists of risk factors automatically selected from multiple parameters (for example, preferably over 400 parameters).

Each parameter is translated into an easy to interpret name and presented along with that parameter's lift value and P-Value.

Each parameter is binned into one of three risk groups and is given a color conveying its risk. The lift, L, of each parameter satisfies 0≤L≤2
High risk for parameters with a lift, 1.65<L≤2 in Red
Moderate risk for parameters with 1<L≤1.65 in yellow
Reduced risk for parameters with 0≤L<1 in Green

The top of the report lists the total number of parameters that the algorithm has selected as well as the distribution of risk levels within the selected parameters. This is done to visually demonstrate the query company's risk and summarize the parameters in a simple and easy to understand manner.

At the bottom of the report, the company's risk score relative to its sector is presented. This helps provide a bottom line for the companies' risk by indicating how much more likely the company is to be involved in a D&O case in comparison to similar companies.

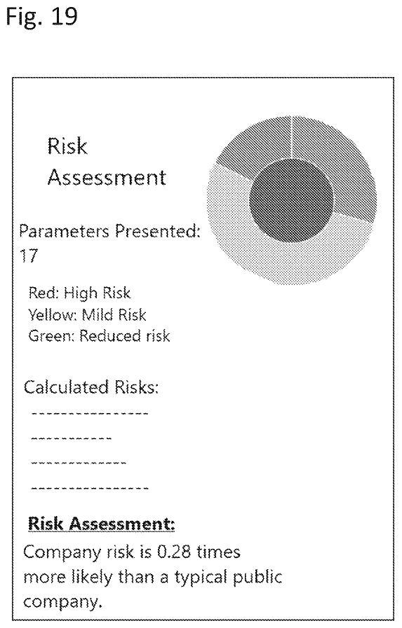

An example of the risk assessment section of a typical report generated by the method and system of the present invention is shown in FIG. 19.

The second part of a typical report is the financial risk factor section.

The financial segment of the risk report incorporates financial Information from annual and quarterly reports as well as stock prices and other related information regarding the company in order to assess and explain the risk of the company being involved in a D&O lawsuit.

The financial segment starts off with the company's financial risk score which is predicted using multiple unique parameters (for example, 80 parameters). It then compares the company's financial risk score to the average score of similar companies.

The body of the financial risk segment is composed of financial parameters which were chosen from the most significant parameters using a t-test. Using the standardized parameters, the smoothed probability density function of that parameter's values given to companies which were involved in a D&O lawsuit (in Red) and for companies which were not involved in a D&O lawsuit (in Green) are computed and displayed. The financial parameter's risk score is then computed at two different resolutions:
By dividing the longer tail of the distribution, the company belongs to, given its value and dividing it by the tail of the other distribution given the parameters value.
The second parameter risk score is computed using a classification model based on that specific parameter to predict the company label, where the value presented is the classifier's probability prediction for the company belonging to label=1.

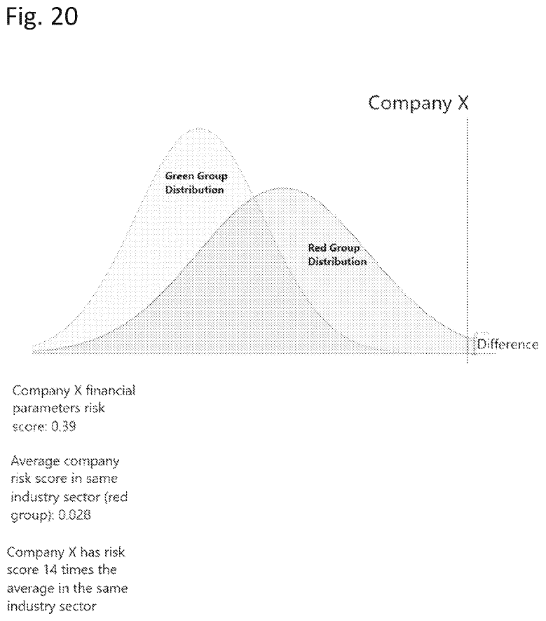

An example of a financial risk section of a typical report is provided in FIG. 20.

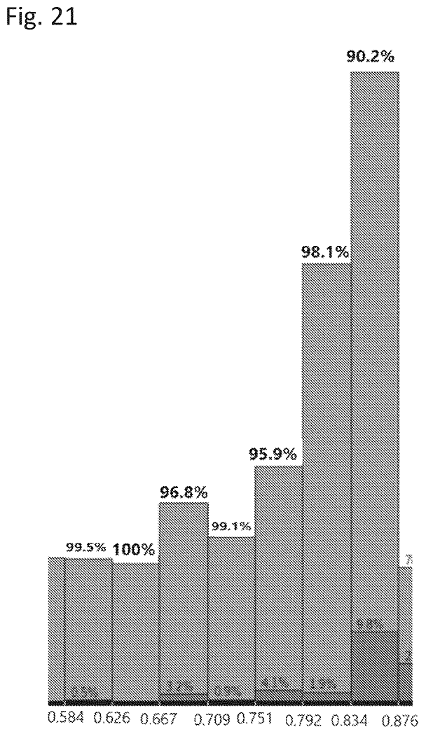

The final section of a typical report or user interface consists of the sector risk comparison, which presents the risk score distribution in the sector of the company in question. This section is also provided for the purpose of insurance portfolio evaluation. The results of this comparison are presented graphically, as shown in FIG. 21.

Each bar of the graph represents a range of risk scores and the number and percentage of:
Companies that were involved in a D&O lawsuit during the last year within that range (in Red);
Companies that were not involved in a D&O lawsuit during the last year (in Green).

These insights allow the end-users/clients to better understand the relative risk of the query company as well as better manage their portfolio by either targeting low risk companies with a low D&O lawsuit prior or exclude high risk companies with a high D&O lawsuit prior.

As disclosed hereinabove, the method of the present invention is generally implemented on one or more computer systems. Typically, such a system will include one or more processing devices, in communication with at least one memory device, at least one storage device and at least one output device, wherein said memory device(s), storage device(s) and/or said processing device contain data derived from a plurality of data sources and computer-readable program code, and wherein said code is capable of being executed in order to perform a method of prediction of the D&O risk of a query company, as disclosed hereinabove and claimed hereinbelow, and to produce a visual report of the outcome of said method of prediction.

Also as mentioned hereinabove, the program code may be generated using any suitable language. In one preferred embodiment, the language used is Python. Other preferred languages include (but are not limited to) C++ and Java.

The terms “database”, “dataframe” and “datasheet” are used interchangeably herein to refer to an organized body of related data, regardless of the manner in which the data or the organized body thereof is represented. Generally, the data are organized in the form of a two-dimensional array.

The terms “processor” and “processing device’ as used herein refer to processing apparatus, programs, circuits, components, systems and subsystems, whether implemented in hardware, software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application-specific integrated circuits, systems on a chip, systems comprised of discrete elements and/or circuits, state machines, virtual machines, data processors, processing facilities and combinations of any of the foregoing.

The terms “storage” and “data storage” as used herein refer to data storage devices, apparatus, programs, circuits, components, systems, subsystems and storage media serving to retain data, whether on a temporary or permanent basis.

The term “output device” refers to any device or medium which may be used to convey to a user any human-readable data such as written language, numerical data, graphical data and so on. Typical output devices for use in the system of the present invention include, but are not limited to, computer screens, display screens on hand-held devices and peripherals such as printers and plotters.

The various hardware components of the computer system may be arranged in a single, integrated computer, such as a desktop or laptop computer, or they may be dispersed into several sub-systems that include a back-end component, such as a data server, or an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, 4G and 5G networks and the computers, handheld devices and networks forming the Internet.

The computer system may include client and server devices. In some cases, the client and server may be remote from each other and interact through a network. The end-user of the report generated by the method of the present invention may interact with the computer system directly, by means of a client-portal providing specific and limited access to that client's D&O assessment reports, or by a graphic user interface on a password-gated portal on a website. Alternatively, the interaction may be indirect, via email, text messaging and so on.

The following non-limiting Examples illustrate the use of the method of the present invention in the assessment of D&O liability. It is to be noted that these working Examples are not intended to limit the invention in any way.

### Example 1

### Results for Application of the Method of the Present Invention to ^{~}1000 Companies

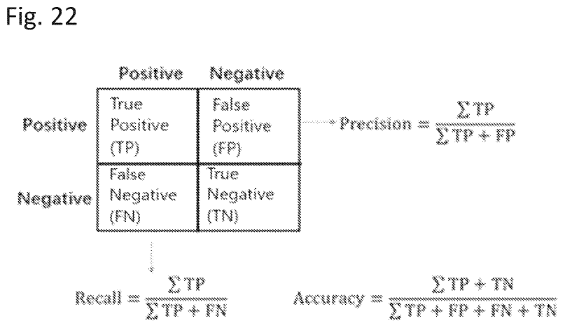

The method of the present invention as disclosed and described herein was applied to approximately 1,000 different companies in order to test the predictive accuracy and precision of said method with regard to D&O lawsuits. Accuracy, recall and precision were measured as shown in FIG. 22.

The results obtained for accuracy, recall (i.e., the ability of the model to find all the relevant cases within the data set), precision and negative predictive value (i.e., a measure of the proportion of subjects with a negative test result who truly do not have the outcome of interest) were as follows:
Accuracy: 0.861
Recall: 0.866
Precision: 0.858
Negative pred value: 0.865

These results indicate that approximately 86% of the companies labeled positive by the method of the present invention actually had D&O charges pressed against them during the following year, thereby confirming the effectiveness of this predictive method.

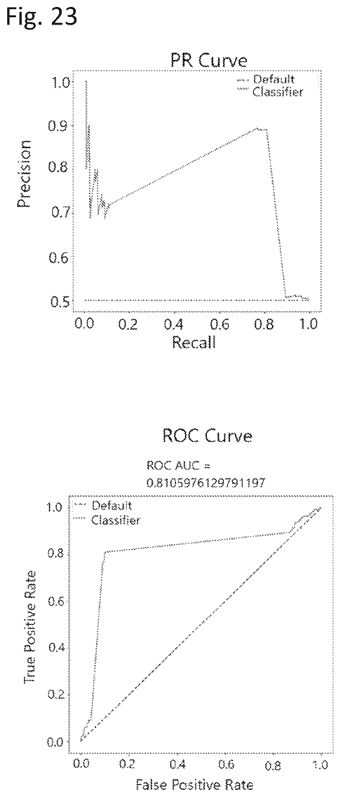

FIG. 23 presents two performance-related graphs for this experiment. The graph on the top is a precision-recall (PR) curve and indicates that the data points are all located above the classifier line (i.e., the random chance level). Similarly, the receiver operating characteristic (ROC) curve on the lower side of the figure also shows that all of the test results are located to the left of the chance level (classifier) line.

### Example 2

### Comparative Study: Contribution of Director and Officer Data to the Precision of the Method of the Present Invention

To compare the contribution of companies' executives' data to the overall precision of the results obtained by the method of the present invention, the following two models for predicting the risk-score of a company for receiving a D&O lawsuit in 2022 were trained:
Model 1—trained and predicted company risk without using executive data
Model 2—trained and predicted company risk using all the data that model 1 uses, with the addition of data concerning the directors and officers of the companies (“executive data”)

For the purposes of this comparison a specific quantile for the companies with the highest D&O risk were selected, ensuring that 90 companies in each model received the highest risk-score (from a total of 7,140 companies).

The results of the models with actual D&O lawsuits were as follows:
Model 1: Among the top 90 companies with the highest risk: 7 received a D&O lawsuit in the following year.
Model 2: Among the top 90 companies with the highest risk: 16 received a D&O lawsuit in the following year.

These results, together with the precision results derived therefrom, are summarized in the following table.

| | # of | # of Companies received | |
|---|---|---|---|
| Model Type | Companies | a D&O lawsuit | Precision |
| Model 1 | 90 | 7 | 7.78% |
| (Without | | | |
| executive data) | | | |
| Model 2 (With | 90 | 16 | 17.78% |
| executive data) | | | |

These results indicate that the incorporation of executive data into the model used by the method of the present invention significantly enhances the predictive precision of said method.

1. A method, performed by a computer system, for the prediction of the directors and officers (D&O) risk of a query company, wherein said method comprises the steps of:
a) Using machine learning to construct a quantitative risk-prediction model based on features produced from data that have been acquired from a plurality of data sources, and to train and validate said model;
b) Deriving the D&O risk of said company using said risk-prediction model;
c) Providing a report which provides a quantitative measure of the D&O risk of said query company;
wherein said features comprise both features related to said query company and features related to the directors and officers of said query company.

2. The method according to claim 1, wherein the step of constructing and training of the risk-prediction model comprises the following sub-steps:
a) acquiring data from a plurality of data sources;
b) processing the acquired data into a form suitable for further processing;
c) merging processed data of different source types into a single datasheet or dataframe, wherein said different source types are selected from the group consisting of company data sources, financial filings, legal case sources and news and social media sources;
d) resolving chosen elements of the processed data into features;
e) selecting features by means of an assessment process that statistically measures the relation of each feature to the D&O risk;
f) applying a decision tree classifier and/or a naïve Bayes classifier to the selected features, in order to create and train the risk-prediction model;

3. The method according to claim 1, wherein the features comprise one or more of the following types of feature:
a) features based on events and/or other qualitative and quantitative data that occurred during the current or past employment of current or past directors and executives;
b) features based on events and/or other qualitative and quantitative data that occurred before current or past employment of current or past directors and executives;
c) features based on events and/or other qualitative and quantitative data that occurred after current or past employment of current or past directors and executives;
wherein the features listed in sections a) to c) are selected from the group consisting of features related to (i) the query company, (ii) features related to a company other than the query company, in which current or past directors and executives have been or still are employed, (iii) features related to current directors and executives, and (iv) features related to past directors and executives.

4. The method according to claim 3, wherein the features comprise features based on D&O lawsuits filed against current or past directors and executives while employed at the query company or at another company.

5. The method according to claim 3, wherein the features comprise features based on D&O lawsuits filed against the query company or against another company in which current or past directors and executive are employed or have been employed in the past.

6. The method according to claim 3, wherein the features comprise features based on the financial parameters and/or financial ratios of the query company and/or one or more companies of current or past employment of current or past directors and executives of the query company.

7. The method according to claim 3, wherein the features comprise features based on formal reports and/or SEC filings of companies at which current or past directors and executives are employed or were employed in the past.

8. The method according to claim 3, wherein the features comprise features based on stock prices and traded values of companies at which current or past directors and executives are employed or were employed in the past.

9. The method according to claim 3, wherein the features comprise features based on company ratings of the query company and/or other companies at which current or past directors and executives are employed or were employed in the past.

10. The method according to claim 9, wherein the company rating is an environmental, social, and governance (ESG) rating.

11. The method according to claim 3, wherein the features comprise features based on news and events related to the query company and/or to other companies at which current or past directors and executives are employed or were employed in the past.

12. The method according to claim 1, wherein the features related to the directors and officers of the query company comprise features pertaining to the employment history of said directors and officers and/or features pertaining to the experience, training, academic degree, gender, of current or past directors and executives of the query company.

13. The method according to claim 1, wherein the features related to the directors and officers of the company comprise features pertaining to lawsuits involving currently serving directors during their period of employment at the query company and/or during their period of employment in other companies.

14. The method according to claim 1, wherein the features related to the directors and officers of the query company comprise features pertaining to lawsuits involving other companies in which said directors and officers concurrently serve or in which they served during periods of prior employment.

15. The method according to claim 1, wherein the D&O risk is computed in the context of a specific market segment.

16. The method according to claim 15, wherein the features used are selected from the group consisting of features pertaining to the query company, features relating to the directors and officers of said company, and features relating to the specific market segment.

17. The method according to claim 1, wherein the features are based on comparing distributions of financial parameters of the query company and on the comparison of the posterior density of a D&O lawsuit for said company.

18. The method according to claim 1, wherein the features are selected from features based on the parameters of sibling companies, parent companies and/or child companies.

19. The method according to claim 1, wherein the quantitative prediction model includes consideration of the features in relation to the geographical location of the query company.

20. The method according to claim 1, wherein the quantitative model further comprises the following step-wise process:
a) prediction of a risk bin based on a model trained in past years;
b) mapping the query company to said risk bin by applying said model to the values of said company;
c) observing the fraction of events within every bin as inferred from considering a more recent history, based on the recent history of other companies that were mapped in said model;
d) computing the risk for the query company as the fraction observed in the bin to which it was mapped.

21. A computer system for use in performing the method according to claim 1, wherein said computer system comprises a computerized processing device, wherein said processing device is in communication with at least one memory device, at least one storage device and at least one output device, wherein said memory device(s), storage device(s) and/or said processing device contain data derived from a plurality of data sources and computer-readable program code, and wherein said code is capable of being executed in order to perform a method of prediction of the D&O risk of a query company, in accordance with claim 1, and to produce a visual report of the outcome of said method of prediction.

22. A software product comprising a non-transitory computer readable/writable medium in which resides computer-readable program code, said code being capable of being executed in order to perform a method of prediction of the D&O risk of a query company, in accordance with claim 1, and to produce a visual report of the outcome of said method of prediction.
